(19) United States
(12) Patent Application Publication
(10) Pub. No.: US 2006/0290018 A1
(43) Pub. Date: Dec. 28, 2006

(54) Process for produicng stamper for direct mastering, and stamper produced by such process and optical disc

(75) Inventors: Yuuko Tomekawa, Ibaraki-shi (JP); Eiichi Ito, Nishinomiya-shi (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 10/567,017

(22) PCT Filed: Feb. 22, 2005
(86) PCT No.: PCT/JP05/02772

§ 371 Date: Feb. 3, 2006

(30) Foreign Application Priority Data
Mar. 12, 2004 (JP) 2004-070415

(51) Int. Cl. B29D 11/00

(52) U.S. Cl. 264/2.5

(57) ABSTRACT

In producing a stamper for molding an optical disc, a master disc which can be obtained from the steps of forming a thermosensitive material layer capable of acting as a negative type by a laser beam on a substrate, irradiating a laser beam to predetermined areas of the thermosensitive material layer so as to partially perform exposure and wet-etching the partially exposed thermosensitive material layer so as to form a fine pits-and-bumps pattern is used as a stamper for injection molding machine. Therefore, minute pits each having a size smaller than the spot of the laser beam of optical limit are formed, thereby providing a stamper with the small number of deficiencies.

### FIELD OF THE INVENTION

The present invention relates to a method for manufacturing a stamper for use in molding optical discs used for reproducing information. Specifically, the present invention relates to a method for manufacturing a stamper for direct mastering that uses the manufactured stamper as a direct molding die.

### BACKGROUND ART

Optical recording medium for recording and reproducing information by irradiation with an light beam has been widely utilized, and expectations are focused on a further increase in their recording densities.

Therefore, in recent years, various optical discs capable of reproducing high-volume image/sound data and digital data have been developed. For example, studies and developments for increasing the storage capacity of an optical disc having a diameter of 12 cm up to a high density of 23.3 to 30 GB are proceeding.

In general, in the manufacturing of optical discs, first of all, a stamper is produced from a master disc. Then, using the resultant stamper, the pattern including fine pits-and-bumps formed on the stamper surface is copied in large quantities on the individual optical discs by injection molding. A schematic diagram of the process of manufacturing the master disc is shown in FIG. 4. In FIG. 4, the reference numeral 501 denotes a substrate; 502 denotes a photosensitive material layer; 503 denotes a light-sensed portion; 504 denotes a concave and convex pattern; 505 denotes a master disc to be used for producing a stamper; 506 denotes a Ni-plated portion; and 507 denotes a stamper.

In FIG. 4, in the process of 4A, a photosensitive material layer 502 is formed by spin coating on a substrate that constitutes the master disc, for example, a surface-polished glass substrate 501. After that, in the process of 4B, a laser beam is converged by a condensing lens, and the photosensitive layer 502 is sensed with the laser beam of which intensity is modulated by the information signals to be recorded. Next, in the process of 4C, the photosensitive layer 502 is developed so as to create marks of the pits-and-bumps or grooves corresponding to the photosensitivity. The resultant product having a pits-and-bumps pattern 504 formed on the substrate 501 is referred to as a master disc 505. In the process of 4D, the master disc 505 is subjected to plating. Normally, the plating is performed using Ni in many cases, and a Ni-plated portion 506 is formed on the master disc 505. The Ni-plated portion 506 is formed by forming a nickel film on a resist by sputtering, and then performing electroplating using the nickel film as electrodes. Next, in the process of 4E, the Ni-plated portion 506 is peeled from the master disc 505, and is molded into the shape of a stamper to be mounted to the injection molding machine so as to provide a stamper 507.

In the case of manufacturing a master disc for high-density optical discs, it is needed to form small signal pits. However, an organic photosensitive material is generally in a photon mode, and thus is sensed with light in correspondence with the amount of irradiation light. Therefore, when the recording laser spot has the shape of Gaussian distribution for example, even the portions irradiated with the both sides of the spot with small amount of irradiation light are partially sensed, and the resultant pit to be recorded creates a spreading shape in correspondence with the irradiation power. For this reason, it is difficult to stably form recording pits each having a size smaller than the spot of optical limit of the recording laser onto the resist layer made of photosensitive material.

Further, an electron beam plotting device and the like has been developed as a device for exposing a pattern onto the photosensitive material layer (for example, Prior art 1: Japanese Unexamined Patent Publication No. 2003-173581). This electron beam plotting device aids to form a fine pattern, that is, to achieve high density, but this device requires to perform plotting operations in high vacuum, and thus has problems that it is large in size and expensive.

In consideration of such problems, instead of the photosensitive material, a thermosensitive material that rises its temperature by light irradiation and changes its state (for example, phase change from an amorphous phase into a crystalline phase) is also developed intensively (for example, Prior art 2: Japanese Unexamined Patent Publication No. 2003-315988). In general, a thermosensitive material changes its state when heated to a certain temperature or higher that is determined by the material. For this reason, the recording laser spot has a shape of Gaussian distribution, and the portion irradiated with the center of the spot is heated to an elevated temperature and changes its state, whereas the portions irradiated with the both sides of the spot with small amount of irradiation are not heated to a sufficiently elevated temperature and do not change their states. Accordingly, as compared with the case of employing a conventional photosensitive material used in a photon mode, recording pits smaller in size can be formed more stably.

In the case where a chalcogen compound that is a typical thermosensitive material is used as a resist, high resolution can be expected, whereas in the mastering process where a master disc such as described above is produced, and then is plated and electroplated so as to provide a stamper, there is a problem that deficiencies appear in the plating step. This problem arises due to the following three reasons:

a) Resistance of the thermosensitive material to a plating liquid at the time of producing a stamper;

b) Chemical reaction between the thermosensitive material and a plating liquid due to the electric conduction through the plating; and

c) Deficiencies due to the attachment of foreign substances.

To avoid such a problem, it is conceivable to employ a method for manufacturing a stamper for direct mastering where a master disc formed with a pattern is directly used as a molding die, without employing the mastering process where the master disc such as described above is produced and a stamper is produced using the master disc. In this method, for example, a photosensitive material on the substrate is exposed and developed, and further bump portions are made to be rigid. After that, the substrate is placed onto a metallic die and is directly used as a stamper. Therefore, according to the stamper for direct mastering, after the exposure and development are performed, a fine pits-and-bumps pattern is formed by the resultant resist. For this reason, this method has an advantage in that there is no need of the mastering process including a plating step, an electroplating step, and a peeling process from the glass substrate.

In this regard, the thermosensitive material described in the Prior art 2 uses a laser beam as a light exposure source instead of a specific light exposure source such as electron beam and ion beam, and can be also utilized in manufacturing a stamper for direct mastering described above.

However, since the thermosensitive material described in the prior art 2 is of a positive type where the exposed portions are removed when developed, the exposure step tends to spend a long time. In addition, since these thermosensitive materials have a low absorption coefficient of laser beam, they exhibit extremely low energy absorption. Consequently, in the exposure step, the thermosensitive materials need to be irradiated with a laser beam having large energy, resulting in increasing the device cost and rendering it difficult to achieve the fine processing. Further, it has been revealed that the bump portions formed of these positive-type thermosensitive material layers do not have sufficient durability as a stamper for direct mastering.

### SUMMARY OF THE INVENTION

The present invention has been made to solve the above-described problems, and an objective thereof is to manufacture a stamper for direct mastering produced by the use of a thermosensitive material as a resist, capable of achieving exposure by a laser beam without using a specific light exposure source such as ion beam and electron beam, and also capable of reducing laser beam energy and achieving exposure in a short time, as well as having excellent durability.

The present invention is directed for a method for manufacturing a stamper for direct mastering, comprising the steps of: forming a thermosensitive material layer capable of acting as a negative type by a laser beam on a substrate; irradiating a laser beam to predetermined areas of the thermosensitive material layer so as to partially perform exposure; and wet-etching the partially exposed thermosensitive material layer so as to form a fine pits-and-bumps pattern.

The master disc manufactured as described above is usable directly as a stamper for molding an optical disc.

### BRIEF DESCRIPTION OF THE DRAWINGS

FIG. 1 is a schematic diagram showing steps of manufacturing a stamper in the present invention;

FIG. 2 is a schematic diagram showing a recording apparatus of the present invention;

FIG. 3 is a cross-sectional schematic diagram of pits of a stamper in the present invention, where FIG. 3A is a diagram showing the case where there is no heat-adjusting layer, and FIG. 3B is a diagram showing the case where there is a heat-adjusting layer; and

FIG. 4 is a schematic diagram showing steps of a conventional method for manufacturing a stamper.

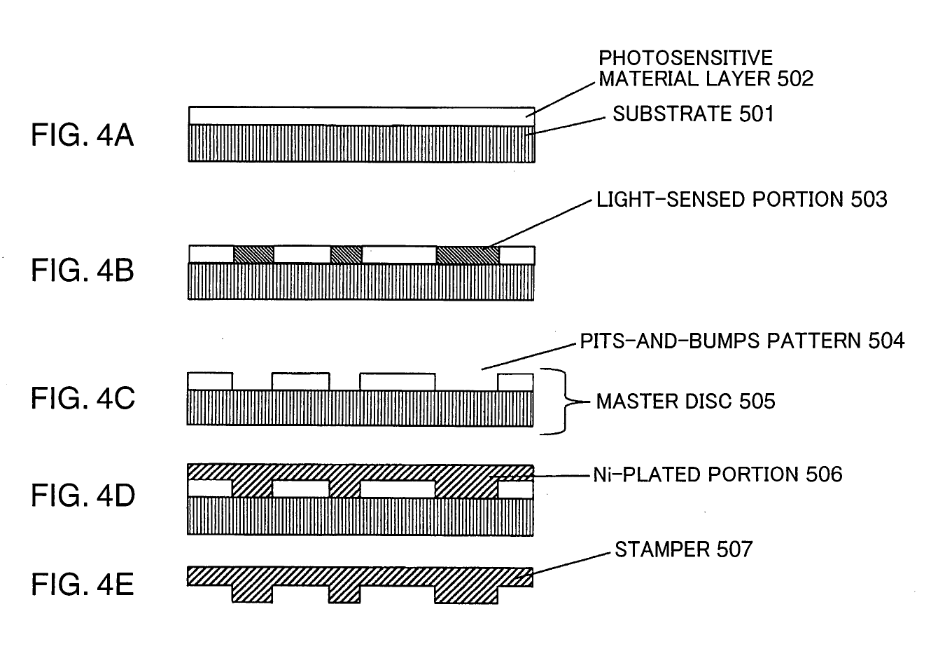

### DESCRIPTION OF PREFERRED EMBODIMENTS

Hereinafter, in an embodiment of an optical recording medium according to the present invention, descriptions will be mainly illustrated as to the case where the present invention is applied to produce a ROM-type optical disc. However, the present invention is not limited to such an optical disc and the shape. The present invention is applicable to any manufacturing steps of producing an injection molding die referred to as a stamper having a pits-and-bumps pattern in the direct mastering for producing optical discs. For example, the present invention is applied to the productions for stampers of various kinds of optical recording mediums having fine pits-and-bumps patterns on their information recording layers such as magneto-optic discs, phase change discs, and the like.

As has already been described, a stamper for direct mastering in the present invention is directed to the case where a master disc which is formed with a predetermined pattern shaped by exposing a negative-type thermosensitive resist to light and etching the same is directly mounted to a molding die and used as a stamper, differing from the case where a predetermined pattern shaped by exposing to light and etching is plated and electroplated to obtain a master disc, and a stamper is manufactured by transferring the predetermined pattern of the master disc.

### First Embodiment

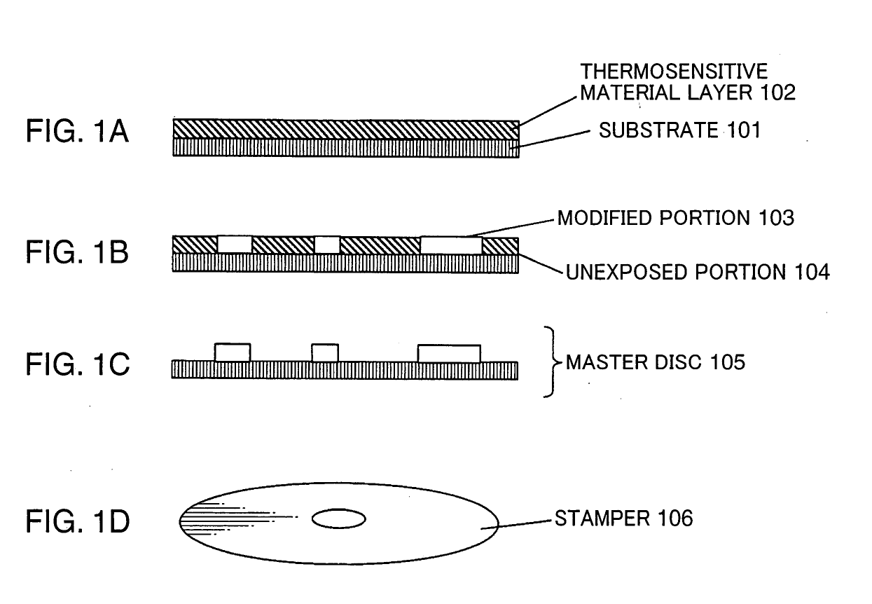

Referring to FIG. 1, a basic method for manufacturing a stamper of the present invention will be described. First of all, a process 1A of forming a thermosensitive material layer 102 onto a substrate 101 will be described. As the substrate 101, a metallic substrate, a silicon-based substrate, a glass substrate or the like may be used. As the metallic substrate, for example, the substrate made of at least one material of nickel, chromium, aluminum, titanium, cobalt, iron, molybdenum, tungsten, boron, copper, and tantalum as a main component, as well as being manufactured by mass-production at low cost, is used. These metallic substrates are preferable since a stamper having a thickness of the same level as of a stamper produced in a conventional mastering process is manufactured with ease. Further, as a silicon-based substrate, silicon compounds such as Si or SiO₂, SiC, or the like are used. Since these compounds are widely utilized in a semiconductor field, they are relatively available easily. As a glass substrate, quartz glass is preferable.

The shape of the substrate is not specifically limited. The shape may be properly selected in consideration of the device to be used in the step of forming the thermosensitive material layer or the exposing step. Further, a discoid stamper-shaped substrate of which inner and outer diameters are processed in such a manner as to mount onto a molding die and match the shape of the optical disc to be produced may be used.

A thermosensitive material layer 102 made of a thermosensitive material is formed on the substrate. In the present invention, different from conventional cases, a thermosensitive material which acts as a negative type when irradiated with a laser beam is used. By use of such a thermosensitive material, exposed portions in the later exposing step changes their natures and remain on the substrate. Thus, it becomes possible to directly form bump portions on the substrate. In this manner, since it becomes possible to form pits by the above-described thermosensitive material layer, needs for a plating step, an electroplating step, a stamper peeling step, and the like are eliminated, thereby simplifying the process.

As the negative-type thermosensitive material to be used in the present invention, it is preferable to use an oxide containing at least one element selected from the group consisting of molybdenum and tungsten. By irradiating a laser beam to these oxides, the portions in which their oxidation numbers or their crystal grain shapes partially (hereinafter, referred to as “modified portions” accordingly) are different from those of the portions not irradiated with the laser beam (hereinafter, referred to as “unexposed portions” accordingly) are formed. Then, the unexposed portions have such natures that can be removed by etching. In addition, since these oxides have hardnesses higher than a chalcogen compound which has conventionally been used, a stamper having excellent durability can be obtained. Further, since these oxides exhibit critical nature changes by thermal amount, each formed pit has clear side shapes, and thus these oxides are preferable for forming a fine pits-and-bumps pattern.

In the present invention, the method for forming the layer of oxide which is the thermosensitive material acting as a negative type onto the substrate will be described later; the specific composition and structure of the oxide which exhibits negative-type thermosensitivity when irradiated with a laser beam are still unknown. It is anticipated that the oxide of the present invention probably is in a state of an excessive amount of oxygen. Thus, it is believed that the layer containing the oxide is formed with portions having an oxidation number which is locally different when irradiated with a laser beam, and unexposed portions by development is only removed. According to the present invention, it is recognized that a layer made of only an oxide of MoO₃ or WO₃ has too low absorption coefficient of laser beam and does not act as a thermosensitive material.

Further, it is also a preferable embodiment that the thermosensitive material layer of the present invention contains metal of molybdenum or tungsten with the above-described oxides. That is, the oxide of molybdenum or tungsten acting as a negative type has transparency, and therefore, has low absorption coefficient. For this reason, when exposure is performed to the thermosensitive material using a laser beam, it is likely that a large amount of laser beam is allowed to pass the thermosensitive layer and sufficient heat generation is hard to obtain. By allowing the thermosensitive material layer to also contain these elemental metals, the absorption coefficient of the layer to the laser beam can be increased. Then, in the exposing step, the exposure can be completed in a short time even by using a laser beam having a low energy amount. A content of the elemental metals described above is not specifically limited as far as the thermosensitive material layer acts as a negative-type thermosensitive material.

In the present invention, one or two of the above-described oxides having different elements, oxidation numbers, and the like may be used in mixture thereof. A thermosensitive material layer containing both of molybdenum oxide and tungsten oxide is especially preferable, because such a thermosensitive material layer has excellent thermal response, resulting in further shortening the exposure time.

The method for forming the thermosensitive material layer of the present invention is not specifically limited, and a conventionally known method may be used. Specifically, for example, method such as sputtering, evaporation, or ion-plating may be employed. Among them, it is preferable to employ reactive sputtering such as magnetron sputtering.

In the case where the thermosensitive material layer containing the above-described oxide is formed by magnetron sputtering, an elemental metal or oxide (for example, MoO₃ or WO₃) may be used as targets. This is because the resultant oxides have excellent uniformity. Further, each of the above-described oxides obtained from the reactive sputtering may be mixed with additives or adjusted in order to contain a proper amount of oxygen. The additives may be properly selected in consideration of the sufficient absorption coefficient to a laser beam, an increase in temperature by irradiation with a laser beam, an etching rate between unexposed portions and modified portions, and the like.

It is preferable that the magnetron sputtering is conducted under the conditions where the sputtering energy is 100 to 1000 W, the partial pressure of argon gas is 0.10 to 0.20 Pa, and the partial pressure of oxygen is 0.05 to 0.10 Pa. As molybdenum oxide and tungsten oxide exhibit either one of negative type and positive type forms depending on their oxidized states, it has been found from studies that, where the conditions fall out of the above-described range, the oxygen amount in the thermosensitive material layer decreases and the oxide which acts as a negative type is hard to obtain.

A method for producing molybdenum oxide or tungsten oxide onto the substrate may be referred to, for example, Japanese Unexamined Patent Publication No. 5-304092.

A thickness of the thermosensitive material layer may be properly determined in accordance with the application of the optical disc to be manufactured, preferably, 40 to 100 nm in thickness.

Next, an exposing step will be described.

As is shown in FIG. 1B, a laser beam is irradiated to the thermosensitive material layer 102 which has been produced as described above in such a manner that the irradiation is made into the pattern corresponding to the fine pits-and-bumps pattern of the thermosensitive material layer 102 so as to partially form modified portions 103.

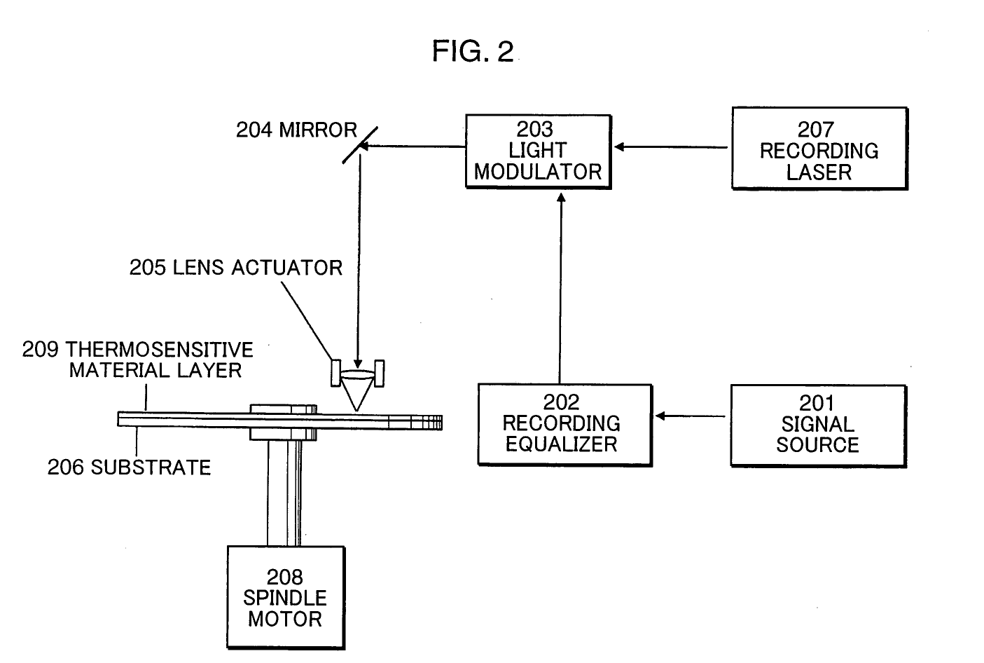

A block diagram of an example of a recording (exposing) apparatus to be used in the exposing step is shown in FIG. 2. The reference numeral 201 denotes a signal source; 202 denotes a recording equalizer; 203 denotes a light modulator; 204 denotes a mirror; 205 denotes a lens actuator; 206 denotes a substrate; 207 denotes a recording laser; 208 denotes a spindle motor; and 209 denotes a thermosensitive material layer. A laser optical system for focus control, and beam expanders for a laser optical system for recording, and the like are omitted.

A signal pulse width of an information signal to be recorded, which has been generated in the signal source 201, is changed by the recording equalizer 202. Then, the information signal is modulated into a pulse string within the signal pulse, and is input into the light modulator 203 so as to modulate the intensity of the laser beam. The intensity-modulated laser beam passes through the mirror 204, and is irradiated in a focused state through the focus-controlled lens of the lens actuator 205 to the thermosensitive material layer 209 on the substrate 206. In the portion irradiated with the laser beam, the nature of the area heated to a predetermined temperature or higher is partially modified so as to form a latent image.

The wavelength of the recording laser 207 in the exposing step of the present invention is not limited as far as the laser beam can be sufficiently absorbed into the thermosensitive material layer and is capable of partially changing the nature of a portion of the thermosensitive material layer. However, since the spot diameter of the laser beam is decreased by use of a short-wavelength laser beam, a wavelength of 410 nm or smaller is preferable. The lower limit thereof is not specifically limited, and for example, a laser beam having a wavelength of 240 nm may be used.

By use of the short-wavelength laser beam such as described above, the heated portion by the laser beam can be restricted locally, thereby forming a fine pattern.

In the present invention, in order to perform high-density thermal recording, it is required to adjust the recording signal pulse length and the recording timing in accordance with the recording signal length, the interval from the recording signal to those before and after it, and the lengths of the recording signals before and after the recording signal. For example, if there is a long recording pulse immediately before the recording pulse, the leading edge of the recording pulse may be delayed, or if there is a long interval without signal immediately before a recording pulse, the leading edge of the recording pulse may be advanced. Further, in order to maintain the signal pit width to be constant within one recording pulse, the recording equalizer makes such a complicated operation as to make the leading edge and final edge of the signal pulse to be relatively longer, whereas to make the middle of the signal pulse to be in a short pulse train.

In the present invention, since the thermosensitive material layer made of molybdenum oxide or tungsten oxide having quick thermal response is used, a pattern with sufficient depth can be formed even by exposure in a short time.

Therefore, the laser beam may be in an energy amount as low as 3.0 mW or lower, or further, 1.6 mW or lower. In addition, the linear velocity thereof may be 4 m/sec or higher. If the linear velocity is too high, the energy amount becomes insufficient and it is likely that a predetermined heat amount is hard to obtain, and thus the linear velocity is preferably 7 m/sec or lower.

Next, the exposed thermosensitive material layer is wet-etched (developed) to form a fine pits-and-bumps pattern on the substrate.

FIG. 1C shows a state after the wet-etching (development). In the present invention, only unexposed portions 104 are removed by utilizing the difference in the etching rate between the modified portions 103 and the unexposed portions 104 which have not been irradiated with the laser beam.

In the etching treatment of the present invention, alkaline etching is employed. In the developing treatment, only the unexposed portions 104 are removed so as to obtain the pits-and-bumps pattern shown in the figure. As the alkaline etching liquid, an alkaline solution which is used conventionally in a development of a photosensitive resist such as 1 to 25% of tetramethyl hydroxide solution, sodium hydroxide aqueous solution, or the like is used. By immersion into such a solution for several minutes, the pits-and-bumps pattern can be formed. The substrate formed with the pits-and-bumps pattern is referred to as a master disc 105.

In the present invention, there is no need of further plating the fine pits-and-bumps pattern formed on the master disc produced as described above. Specifically, as shown in FIG. 1D, by processing the master disc 105 obtained in the step 1C into predetermined inner and outer shapes to be mounted to an injection molding machine, a stamper 106 for direct mastering is obtained.

After that, the stamper is mounted to the die of the molding machine for optical disc, and a large amount of copied optical discs can be manufactured by performing injection molding. In the molding, a conventionally known resin may be used as a resin material. Specifically, a polycarbonate resin may be exemplified as a preferable resin.

At present, in the manufacturing of CD, DVD, or the like, one-hundred thousand pieces of optical discs can be manufactured from one stamper. It has been confirmed that, even after the injection molding was conducted one-hundred thousand times, the stamper of this embodiment exhibited no change in shape and no deterioration was observed in the characteristic of the signal reproduced from the optical discs. Therefore, the stamper for direct mastering produced in the manufacturing method of this embodiment has no problem in practical use and can be used in the production of optical discs.

As described above, in the method for manufacturing a stamper for direct mastering of the present invention, after the fine pits-and-bumps pattern of the resist is formed, there is no need of plating step, electroplating step and stamper peeling step, and manufacturing devices used for these steps, and thus a large reduction in manufacturing time can be achieved and the cost can be reduced.

In addition, even after the injection molding is conducted one-hundred thousand times, the stamper of this embodiment exhibits neither change nor deterioration in its surface shape, and no deterioration is observed in the characteristic of the signal reproduced from the obtained optical discs, and thus the stamper has no problem for use in manufacturing and is usable as a stamper for optical discs.

### Second Embodiment

In the present invention, it is also a preferable embodiment that, in producing the stamper of the first embodiment, a heat-adjusting layer having low thermal conductivity is provided between the thermosensitive layer and the substrate. Hereinafter, the stamper to be produced according to this embodiment will be described: since the substrate, the thermosensitive material, and the like are same as those of the first embodiment, their descriptions will be omitted. In the present invention, the heat-adjusting layer means a layer disposed between the substrate and the thermosensitive material layer and capable of adjusting a heat amount provided by the laser beam to be used for modifying the thermosensitive material.

When molybdenum oxide or tungsten oxide is used as the negative-type thermosensitive material, the film temperature of the thermosensitive material layer elevates as the laser beam is irradiated, whereas the heat amount thereof is dispersed by thermal conduction. In particular, when a substrate of metal or the like having thermal conductivity larger than that of the thermosensitive material layer is used as the substrate, the heat generated by the laser beam transfers to the substrate, thereby it is likely that the heat amount required for modifying the thermosensitive material is short.

In the present invention, in order to overcome the above-described problem, the heat-adjusting layer having thermal conductivity smaller than that of the thermosensitive material layer is formed between the thermosensitive material layer and the substrate. By doing so, a fine pattern can be recorded with low energy. Specifically, by forming the heat-adjusting layer between the substrate and the thermosensitive material layer, the thermal conduction to the substrate is reduced and the temperature of the thermosensitive material layer can be maintained. As a result of this, the formation of the modified portion of the thermosensitive material layer can be achieved by a laser beam with small power. In addition, recording is enabled at high linear velocity even if the power of the laser beam is small.

In the present invention, the heat-adjusting layer preferably has the thermal conductivity of 0.15 to 0.8 W/K·m, and more preferably, the thermal conductivity of the heat-adjusting layer is one-tenth or lower than that of the thermosensitive material layer. By providing such a heat-adjusting layer having low thermal conductivity, even if the thermosensitive material layer contains a large amount of molybdenum oxide or tungsten oxide having a low absorption coefficient, recording by exposure in a short time is enabled without increasing the energy amount of the laser beam. The thermal conductivity is a value measured by a Quick Thermal Conductivity Meter (Kyoto Electronics Manufacturing Co., Ltd).

In the present invention, the heat-adjusting layer may be any one of a layer made of resin and a layer made of inorganic material as far as they can provide the above-described difference in the thermal conductivities. In particular, a heat-adjusting layer made of resin is preferable.

Examples of the above-described resin include acryl-based resins, nylon-based resins, polyethylene-based resins, and the like having low thermal conductivity described above. Among them, it is preferable to use acryl-based resin. It has been confirmed in the present invention that the heat-adjusting layer made of acryl-based resin is excellent in the property of retaining heat required for modifying of the molybdenum oxide or tungsten oxide, and in addition, energy saving and the time reduction in the recording pattern can be also achieved.

As a step of forming the heat-adjusting layer made of resin, the solution of the above-described resin is spin-coated onto the substrate into a predetermined thickness. The thickness of the heat-adjusting layer made of resin is not specifically limited, and preferably, 50 to 100 nm.

As the inorganic material for use in the heat-adjusting layer having the low thermal conductivity described above, dielectric substances or metals may be used. As the dielectric substances, dielectric materials such as Si₃N₄, SiO₂, ZnS, Al₂O₃, or the like can be specifically exemplified. Further, as the metals, Al, Ag, Au or the like can be exemplified.

Further, among the above-described inorganic materials, it is preferable to use an inorganic material having absorption coefficient of the laser beam larger than that of the thermosensitive material layer. Specifically, molybdenum oxide or tungsten oxide which is the negative-type thermosensitive material has low absorption coefficient, and allows large amount of laser beam to transmit therethrough as described above. For this reason, the irradiated laser beam is not effectively utilized, and it is required to increase the intensity of laser beam to achieve predetermined recording. In addition, it is likely that this makes it difficult to form a fine pattern. Therefore, by providing the heat-adjusting layer made of inorganic material having large absorption coefficient, even if the thermosensitive material layer having small absorption coefficient is formed thereon, the energy of the laser beam can be effectively utilized.

The heat-adjusting layer made of inorganic material such as described above preferably has an absorption coefficient of 0.8 or higher with respect to the laser beam having a recording wavelength of 240 to 410 nm. As such an inorganic material, for example, ZnS, Al, Ag, Au, and the like can be exemplified.

As a step of forming the heat-adjusting layer made of inorganic material such as described above, a conventionally known method for forming a dielectric film or a metallic film such as sputtering and deposition may be employed. The thickness of the heat-adjusting layer made of inorganic material layer is not specifically limited, and for example, the thickness of 50 to 100 nm is preferable.

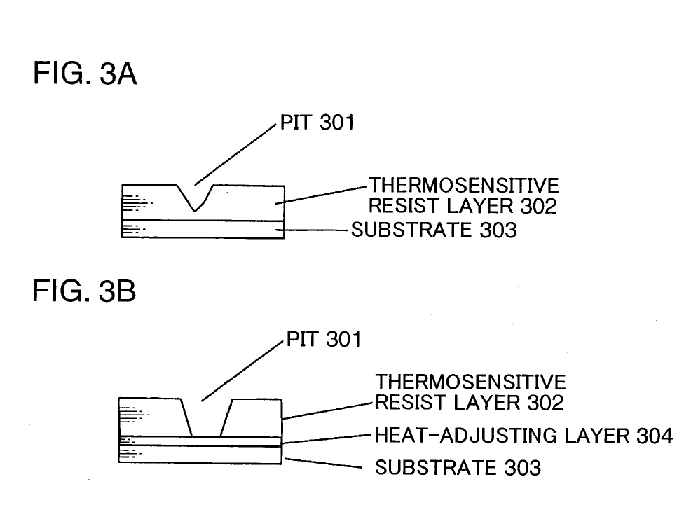

FIG. 3 shows an expanded cross-sectional view of an essential part of a master disc of this embodiment. In the drawing, the reference numeral 301 denotes a pit; 302 denotes a thermosensitive resist layer; 303 denotes a substrate; and 304 denotes a heat-adjusting layer. Further, FIGS. 3A and 3B show a comparison between cross -sectional shapes in the peripheries of the pits when a laser beam at the same level is irradiated, where FIG. 3A shows a structure including no heat-adjusting layer, and FIG. 3B shows a structure including a heat-adjusting layer 304. In the second embodiment, the same steps as of the first embodiment in the method for manufacturing a stamper of the first embodiment can be employed for forming the substrate and thermosensitive material layer, except that the heat-adjusting layer is provided.

In FIG. 3B, the existence of the heat-adjusting layer 304 makes it possible to provide a sufficient heat amount to the thermosensitive resist layer 302 when a recording laser beam is irradiated thereto. As a result, modified portions can be formed with smaller recording power. The reason thereof is assumed that the heat conductivity is smaller than that of the substrate.

For example, when an optical disc having a predetermined characteristic with respect to a wavelength of 410 nm is produced in the case where an acryl-based resin is used in the heat-adjusting layer 304 and molybdenum oxide is used in the thermosensitive resist layer 302, recording is enabled at linear velocity twice as fast as the case including no acryl-based resin. Therefore, the time required for recording can be reduced to half. As a result of reduction in the recording time, the attachment of foreign substances during recording can be decreased.

In the etching treatment after the exposing step, the heat-adjusting layer 304 may be left to be used as a stamper as is shown in FIG. 3B, or alternatively, it may be removed. In the case of the heat-adjusting layer made of resin, in consideration of the attachment during the molding step, it is preferable to perform an etching treatment to etch up to the substrate surface for removing the resin layer.

### Third Embodiment

In the present invention, the fine pits-and-bumps pattern may be formed on the substrate in the first embodiment.

Specifically, in the etching treatment, the pattern including the bump portions formed of the modified portions in the exposing step may be used as an etching mask. In the first embodiment, though the etching is stopped when the unexposed portions are etched(developed) by the etching treatment, the substrate may be further etched to form a fine pits-and-bumps pattern on the substrate as is conducted in the etching step utilized in a mastering method.

As the substrate to be used in such an embodiment, the same type of the substrate as of those employed in the above-described embodiments may be used; however, it is preferable to use a metal plate taking strength into consideration.

Hereinafter, the present invention will be specifically described by way of examples, and it should be noted that the present invention is not limited to these examples.

### EXAMPLE 1

Experiment 1

In this experiment, a thermosensitive material layer was formed onto a nickel substrate by means of reactive sputtering using a molybdenum target.

A molybdenum target was attached to a direct current magnetron sputtering device. After a substrate was fixed on a substrate holder, a chamber was vacuum-evacuated by a cryopump until high vacuum of 1×10⁻⁴ Pa or lower was reached. While continuing vacuum evacuation, Ar gas was introduced up to 0.10 Pa into the chamber and then O₂ gas was introduced up to 0.08 Pa. Next, while rotating the substrate, a direct current power (500 W) was applied to the molybdenum target to form a film such that the film thickness of a molybdenum oxide became 80 nm in 5 minutes of a film forming time. The resultant thermosensitive material layer had a color which was assumed to be derived from the mixture of the molybdenum oxide and molybdenum.

A predetermined pattern was recorded at a wavelength of 405 nm by the exposing device shown in FIG. 2 while the substrate formed with the thermosensitive material layer was rotated. The exposure was conducted under the conditions: NA was 0.95; the recording power of laser beam was 1.6 mW; and the linear velocity was 4.0 m/sec.

Next, the thermosensitive material layer was immersed into 10% tetramethyl ammonium hydroxide aqueous solution for 5 minutes. Since the unexposed portions were removed in this etching treatment, it was confirmed that the above-described molybdenum oxide formed in the reactive sputtering was a negative-type thermosensitive material. The unexposed portions were completely removed and development was conducted, and fine pits each having a track pitch of 0.32 μm and the shortest pit length of 0.14 μm were formed. The etching rate was 10:1.

After that, the master disc formed with the fine pits was processed to have inner and outer shapes of predetermined diameters in such a manner that the master disc was employed in injection molding, and a stamper for direct mastering was produced.

The produced stamper was placed to a predetermined injection molding machine, and a molten polycarbonate resin was injected therein and compressed so as to form a base element for optical disc. A reflection film containing aluminum as a main component was formed into a thickness of 40 nm onto the base element for optical disc, and a polycarbonate sheet having a thickness of 0.1 mm was further formed thereon so as to produce an optical disc. It was possible to produce one-hundred thousand pieces of optical discs having desired characteristics.

Experiment 2

The same steps as of the experiment 1 were repeated to produce a stamper for direct mastering, except that a heat-adjusting layer made of ZnS (the thermal conductivity: 0.75 W/K·m; the ratio between the thermal conductivity and that of the thermosensitive material layer: 1/104; and the absorption coefficient of laser beam: 0.91) was formed between the substrate and the thermosensitive material layer in the production of the stamper of the experiment 1.

The heat-adjusting layer was formed by sputtering into a thickness of 80 nm using ZnS as a target in an Ar atmosphere.

The steps of the experiment 1 were repeated using the stamper produced as described above to mold optical discs, and it was possible to produce one-hundred thousand pieces of optical discs.

Experiment 3

The same steps as of the experiment 1 were repeated to produce a stamper for direct mastering, except that a heat-adjusting layer made of acryl-based resin (Optomer manufactured by JSR Corporation, the thermal conductivity: 0.18 W/K·m; and the ratio between the thermal conductivity and that of the thermosensitive material layer: 1/540) was formed between the substrate and the thermosensitive material layer in the production of the stamper of the experiment 1.

The heat-adjusting layer was formed by applying an acryl-based resin onto a nickel substrate into a thickness of 60 nm by spin coating. In the etching treatment, etching was performed until the resin layer completely removed.

The steps of the experiment 1 were repeated using the stamper produced as described above to mold optical discs, and it was possible to produce one-hundred thousand pieces of optical discs.

Experiment 4

The same steps as of the experiment 3 were repeated to produce a stamper for direct mastering, except that a mixture of molybdenum oxide and tungsten oxide was used as a thermosensitive material.

Reactive sputtering was performed using a substrate formed with a heat-adjusting layer made of acryl-based resin of the experiment 3 as a substrate. In the reactive sputtering, a molybdenum-tungsten alloy was used as a target (the ratio of Mo:W in the target was 7:3). After the substrate was fixed on a substrate holder, a chamber was vacuum-evacuated by a cryopump until high vacuum of 2.6×10⁻⁴ Pa or lower was reached. While continuing vacuum evacuation, Ar gas was introduced up to 0.16 Pa into the chamber and then O₂ gas was introduced up to 0.05 Pa. Next, while rotating the substrate, a direct current power (500 W) was applied to the target to form a film such that the thickness became 50 nm.

Next, the steps of the experiment 3 were repeated to perform exposure and etching treatment. Since the unexposed portions were removed in the etching treatment, it was confirmed that the thermosensitive material formed in the reactive sputtering was a negative type. The etching rate was 13:1.

The steps of the experiment 1 were repeated using the stamper produced as described above to mold optical discs, and it was possible to produce one-hundred thousand pieces of optical discs.

Experiment 5

The same steps as of the experiment 4 were repeated to produce a stamper for direct mastering, except that a film made of mixture of MoO₃ and WO₃ was used.

As a substrate, a substrate formed with the heat-adjusting layer made of acryl-based resin of the experiment 4 was used, and a molybdenum-tungsten alloy was used as a target. After a substrate was fixed on a substrate holder, a chamber was vacuum-evacuated by a cryopump until high vacuum of 2.6×10⁻⁴ Pa or lower was reached. While continuing vacuum evacuation, Ar gas was introduced up to 0.16 Pa into the chamber and then O₂ gas was introduced up to 0.14 Pa. Next, while rotating the substrate, a direct current power (500 W) was applied to the target to form a film made of MoO₃ and WO₃ such that a thickness became 50 nm.

Next, the steps of the experiment 4 were repeated to perform recoding by means of a laser beam (recording power was 3 mW), and then, etching was performed, but no recording pattern could be formed. From this result, it was confirmed that these oxides were not thermosensitive materials which act as a negative type when exposed to a laser beam.

### EXAMPLE 2

An influence of the thermosensitive material layers and the heat-adjusting layers obtained in the experiments 1 to 4 of the example 1 to the exposure time (recording time by laser beam) required for pattern formation was studied.

In the production of the stampers of the experiments 1 to 4, a predetermined pattern was formed on each thermosensitive material layer by varying the linear velocity of the laser beam and etching, so as to produce stampers which were recorded with different recording times from each other. The patterns were formed so as to provide 25 GB optical discs. All of the stampers were in the pattern partially formed with an area having a track pitch of 0.32 μm and the shortest pit length of 0.149 μm for S/N ratio measurement. Optical discs were produced using the stampers which were recorded with different recording times. Each of the produced optical discs was reproduced by a recording and reproducing head having NA of 0.85 and a laser wavelength of 405 nm. Each recording time by the laser beam required to obtain a stamper used for producing an optical disc, which exhibited the S/N ratio of 45 dB or larger in a certain area having the shortest pit length of 0.149 μm, is shown in Table 1.

TABLE 1

| | Recording time by |
|---|---|
| Experiment No. | laser beam (minutes) |
| 1 | 450 |
| 2 | 280 |
| 3 | 210 |
| 4 | 110 |

As is shown in Table 1, each stamper for direct mastering manufactured according to the present invention can achieve the recording time reduction by forming a heat-adjusting layer between the substrate and the thermosensitive material layer. In particular, it is understood that the experiment 3 where the heat-adjusting layer made of a resin layer is formed and the experiment 4 where the thermosensitive material layer containing both of molybdenum oxide and tungsten oxide achieved further reduction in the recording time by laser beam.

As described above, the negative-type thermosensitive material layer is formed on the substrate, and then is subjected to recording by a laser beam and wet-etching so as to form a fine pits-and-bumps pattern thereon, and the resultant substrate is processed as a stamper for directly molding an optical disc, whereby the number of steps required for producing the stamper can be significantly reduced, and a stamper having the small number of deficiencies can be produced efficiently. By employing this technique to a stamper for substrate of high-density optical disc, it becomes possible to provide an optical disc capable of reproducing good signals with low cost and excellent yield.

Although the present invention has been described in detail, the foregoing descriptions are merely exemplary at all aspects, and do not limit the present invention thereto. It should be understood that an enormous number of unillustrated modifications may be assumed without departing from the scope of the present invention.

### INDUSTRIAL APPLICABILITY

The method for manufacturing a stamper of the present invention is useful as a method for manufacturing a stamper for optical recording medium. In particular, the method is preferable in the case of manufacturing a stamper for direct mastering where a master disc is directly utilized for molding optical discs.

1-13. (canceled)

14. A method for manufacturing a stamper for direct mastering, comprising the steps of:
forming a thermosensitive material layer capable of acting as a negative type by a laser beam on a substrate;
irradiating a laser beam to predetermined areas of said thermosensitive material layer so as to partially perform exposure; and
wet-etching said partially exposed thermosensitive material layer so as to form a fine pits-and-bumps pattern.

15. A method for manufacturing a stamper for direct mastering according to claim 14, wherein said thermosensitive material layer contains an oxide of at least one element selected from the group consisting of molybdenum and tungsten.

16. A method for manufacturing a stamper for direct mastering according to claim 14, wherein the step of forming said thermosensitive material layer comprises a reactive sputtering step which uses a target containing at least one element selected from the group consisting of molybdenum and tungsten.

17. A method for manufacturing a stamper for direct mastering according to claim 16, wherein a partial pressure of argon gas is 0.1 to 0.20 Pa, an oxygen partial pressure is 0.05 to 0.10 Pa, and sputtering energy is 100 to 1000 W in said reactive sputtering step.

18. A method for manufacturing a stamper for direct mastering according to claim 14, further comprising the step of forming a heat-adjusting layer between said substrate and said thermosensitive material layer.

19. A method for manufacturing a stamper for direct mastering according to claim 18, wherein a thermal conductivity of said heat-adjusting layer is one-tenth or lower than a thermal conductivity of said thermosensitive material layer.

20. A method for manufacturing a stamper for direct mastering according to claim 18, wherein said heat-adjusting layer contains at least one resin selected from the group consisting of acryl-based resin, nylon-based resin, and polyester-based resin.

21. A method for manufacturing a stamper for direct mastering according to claim 18, wherein said heat-adjusting layer contains at least one inorganic material selected from the group consisting of dielectric substances and metals, and said inorganic material has an absorption coefficient of 0.8 or higher with respect to a wavelength of said laser beam.

22. A method for manufacturing a stamper for direct mastering according to claim 14, wherein said substrate is in the shape of disc-like stamper of which inner and outer diameters are processed.

23. A method for manufacturing a stamper for direct mastering according to claim 14, further comprising the step of processing said substrate into the shape of stamper.

24. A method for manufacturing a stamper for direct mastering according to claim 14, wherein the step of forming a fine pits-and-bumps pattern by said wet-etching comprises a step of etching said substrate so as to form the fine pits-and-bumps pattern using said partially exposed thermosensitive material layer as an etching mask.

25. A stamper for direct mastering manufactured by means of a method of claim 14.

26. An optical disc to be manufactured using the stamper of claim 25.
